(19) United States
(12) Patent Application Publication
(10) Pub. No.: US 2018/0089354 A1
(43) Pub. Date: Mar. 29, 2018

(54) SLEW WINDOW SHIFT PLACEMENT METHOD TO REDUCE HOT SPOTS AND RECOVER VT/AREA

(71) Applicant: GLOBALFOUNDRIES INC., GRAND CAYMAN (KY)

(72) Inventors: Alok Chandra, Bangalore (IN); Jeanne P. Bickford, Essex Junction, VT (US); Venkatasreekanth Prudvi, Bangalore (IN); Sandeep Prajapati, Bangalore (IN); Anand Kumaraswamy, Bangalore (IN)

(73) Assignee: GLOBALFOUNDRIES INC., GRAND CAYMAN (KY)

(21) Appl. No.: 15/276,840

(22) Filed: Sep. 27, 2016

(51) Int. Cl. G06F 17/50

(52) U.S. Cl. CPC G06F 17/5045; G06F 17/5031

(57) ABSTRACT

Systems and methods for reducing hot spots and recovering Vt/area to improve chip performance in an integrated circuit design. According to the method, physical grid areas for an IC chip are defined and a switching window for library elements of an integrated circuit design in a region of the chip is determined. Points of peak current for library elements within the switching window are determined. A grid area is selected and library elements having additional usable timing margin are identified. The library elements are prioritized, based on location in the grid area according to peak current and usable timing margin. Based on order of priority, the timing of signal paths in the grid area may be adjusted in order to misalign points of peak current and maintain current density in the region below a threshold and/or a library element within the grid area may be changed to recover area within the grid area.

### BACKGROUND

The present disclosure relates to integrated circuit design and more particularly to modification of the design to reduce hot spots and recover Vt/area on the integrated circuit chip.

Integrated circuits are used for a wide variety of electronic applications, from simple devices to the most complex computer systems. A microelectronic integrated circuit (IC) chip can generally be thought of as a collection of logic cells with electrical interconnections between the cells, formed on a semiconductor substrate.

In modern integrated circuits, a large number of individual circuit elements, such as field effect transistors in the form of CMOS, NMOS, PMOS elements, resistors, capacitors and the like may be formed on a single chip area. Typically, feature sizes of such circuit elements are steadily decreasing with the introduction of every new circuit generation, to provide currently available integrated circuits with an improved degree of performance in terms of speed and/or power consumption. A reduction in size of transistors is an important aspect in steadily improving device performance of complex integrated circuits, such as CPUs.

Although transistor elements are the dominant circuit element in highly complex integrated circuits, which substantially determines the overall performance of these devices, other components, such as capacitors and resistors, may be included. Due to high current density at a given time, new technologies may have more hot spots on the integrated circuit chip. For purposes of this disclosure, a hotspot refers to a specific area on an IC chip that exhibits a relatively high operating temperature as compared to the normal operating temperature range exhibited across the IC chip.

The primary reason for the high current density at a given time is the short circuit current in the transistor, as illustrated in FIG. 1. Millions of transistors switching in the same timing window cause a huge short circuit current (I_{sc}). Some additional factors causing hot spots in the chip can include: chip density, device shrink, and concentration of power sources or sinks. This may be due to placement of cells in the chip, high frequency elements in the integrated circuit, and/or current leakage among adjacent elements.

Hot spots create reliability, functionality, and timing issues for the integrated circuit, such as
Electromigration (largest reliability limiter in newer technologies)
Voltage Drop (IR)
Ground bounce causing impact to transistor characteristics, particularly timing.

As mentioned above, an IC may include a very large number of cells and require complicated connections between the cells. A cell is a group of one or more circuit elements such as transistors, capacitors, resistors, inductors, and other basic circuit elements grouped to perform a logic function. Cell placement in semiconductor fabrication involves a determination of where particular cells should be located on the surface of an integrated circuit device.

However, in certain circuit layouts, while use of a higher threshold voltage (Vt) would lower leakage and total power, such a shift is not possible because it would exceed maximum local current density, which happens when the number of electronic devices within a given area becomes too large. That is, a density of the electronic devices in the area is too high, such that the amount of current being passed between the electronic devices within the area becomes infeasible. The circuit layout may not only fail to pass design rule checking, but the circuit itself may be unable to function normally. In other circuit layouts where leakage is a smaller contribution to total power, it is desirable to move to lower Vts and reduce chip area.

In other words, if too many devices within a region switch at the same time a very high current density can result, which leads to hot spots and electromigration (EM) failures.

Cell placement in semiconductor fabrication involves a determination of where particular cells should be located on the surface of an integrated circuit device. Vt/area recovery is an important operation in an electronic design automation (EDA) flow. Different devices in a cell may have different performance characteristics. Vt/area recovery controls current leakage based on device performance and may be used to reduce the die-size of an integrated circuit by moving to a lower performance device. Furthermore, Vt/area recovery can facilitate design convergence: the recovered area can be used at a later stage in the design flow for satisfying design requirements.

### SUMMARY

In view of the foregoing, disclosed herein are embodiments of a method, system, and computer program product for reducing hot spots and recovering Vt/area in an IC design in order to improve chip performance in an integrated circuit design. In these embodiments, the timing signal for some library elements is shifted in order to shift the peak current point. In particular, the present disclosure provides a method to determine points of peak current for the library elements within a switching window and adjust the timing of signal paths in the region to delay or speed up switching of the library elements within the region in order to misalign the points of peak current so that at any given time the current density will be below some threshold—in order to avoid hotspots and, thereby avoid EM fails or other hotspot-related issues.

According to a method, a switching window for library elements of an integrated circuit design in a region of an integrated circuit chip is determined. Points of peak current for the library elements within the switching window are determined. The timing of signal paths in the region is adjusted to delay or speed up switching of the library elements within the region in order to misalign the points of peak current and maintain current density in the region below a predetermined threshold.

According to a method, physical grid areas for an integrated circuit chip are defined. For each physical grid area, a switching window for library elements of an integrated circuit design is determined. Points of peak current for the library elements within the switching window are determined. A physical grid area of the IC chip having peak current density is selected. Target library elements in the physical grid area having additional usable timing margin are identified. The target library elements are prioritized, based on physical location in the physical grid area according to the peak current and the additional usable timing margin. Based on order of priority of the target library elements, one of the library elements within the physical grid area of the IC chip is changed to recover area within the physical grid area of the IC chip.

Also disclosed herein is a computer program product for reducing hot spots and recovering Vt/area to improve chip performance in an integrated circuit design. This computer program product can include a computer readable storage medium with program instructions embodied therewith (e.g., stored thereon). The program instructions can be readable and executable by a computerized device to cause the computerized device to perform a method. According to the method, a switching window for library elements of an integrated circuit design in a region of an integrated circuit chip is determined. Points of peak current for the library elements within the switching window are determined. The timing of signal paths in the region is adjusted to delay or speed up switching of the library elements within the region in order to misalign the points of peak current and maintain current density in the region below a predetermined threshold.

### BRIEF DESCRIPTION OF THE DRAWINGS

The systems and methods herein will be better understood from the following detailed description with reference to the drawings, which are not necessarily drawn to scale and in which:

FIG. 1 illustrates the condition of peak current in a library element;

FIG. 2 shows hotspots on a chip for illustrating aspects of systems and methods herein;

FIG. 3 illustrates timing slew shifting according to aspects of systems and methods herein;

FIG. 4 illustrates peak current shift according to aspects of systems and methods herein;

FIG. 5 illustrates peak current shift according to aspects of systems and methods herein;

FIGS. 6A-6F show graphs of peak current and current density according to aspects of systems and methods herein;

FIG. 7 is a flow chart illustrating aspects of systems and methods herein;

FIG. 8 shows a chip divided into grids illustrating aspects of systems and methods herein;

FIG. 9 is a graph of peak current illustrating additional aspects of systems and methods herein;

FIG. 10 is a flow chart illustrating aspects of systems and methods herein; and

FIG. 11 is a schematic diagram illustrating an exemplary hardware system that can be used in the implementation of the systems and methods herein.

### DETAILED DESCRIPTION

For a general understanding of the features of the disclosure, reference is made to the drawings. It will be readily understood that the systems and methods of the present disclosure, as generally described and illustrated in the drawings herein, may be arranged and designed in a wide variety of configurations in addition to the systems and methods described herein. In the drawings, like reference numerals have been used to identify identical elements. While the disclosure will be described hereinafter in connection with specific systems and methods thereof, it will be understood that limiting the disclosure to such specific systems and methods is not intended. Thus, the following detailed description of the systems and methods, as represented in the drawings, is not intended to limit the scope defined by the appended claims. On the contrary, it is intended to cover all alternatives, modifications, and equivalents as may be included within the spirit and scope of the disclosure as defined by the appended claims.

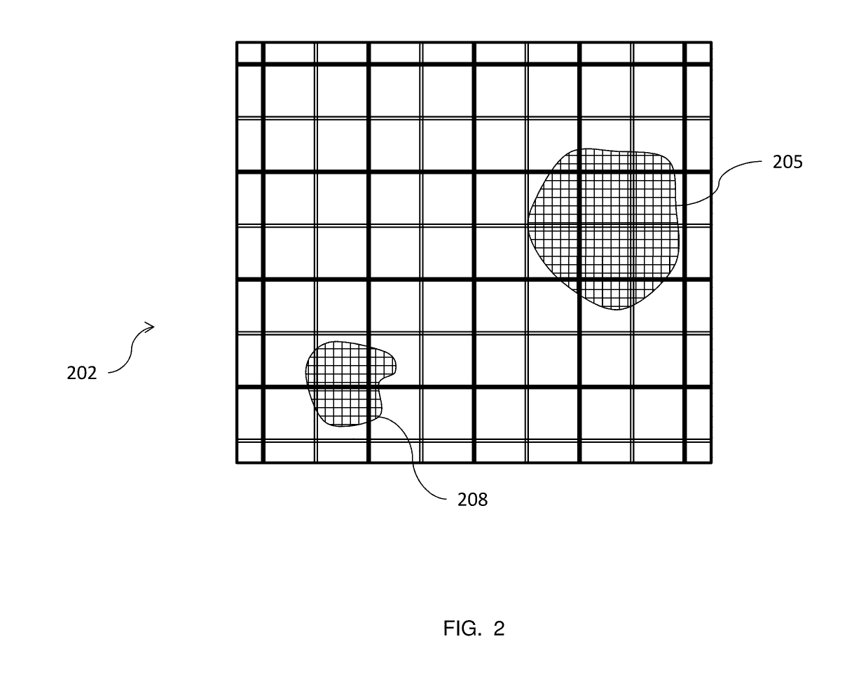

FIG. 2 shows an integrated circuit (IC) chip, indicated generally as 202 having hot spots 205, 208. As described above, the primary reason for the high current density at a given time is the short circuit current in the transistor. High current density can lead to hot spots in the chip 202. Some factors causing hot spots 205, 208 in the chip 202 can include: chip density, device shrink, and concentration of power sources or sinks. This may be due to placement of cells in the chip, high frequency elements in the integrated circuit, and/or current leakage among adjacent elements.

A library containing library elements can list multiple different library elements (also referred to as cells or standard cells) that can be incorporated into an IC under design in a specific technology node and, specifically, can contain library files (.libs) for each of those library elements. A given library element can represent a single device with specific features or can represent a set of devices with specific features and the interconnect structure(s) that connect those devices.

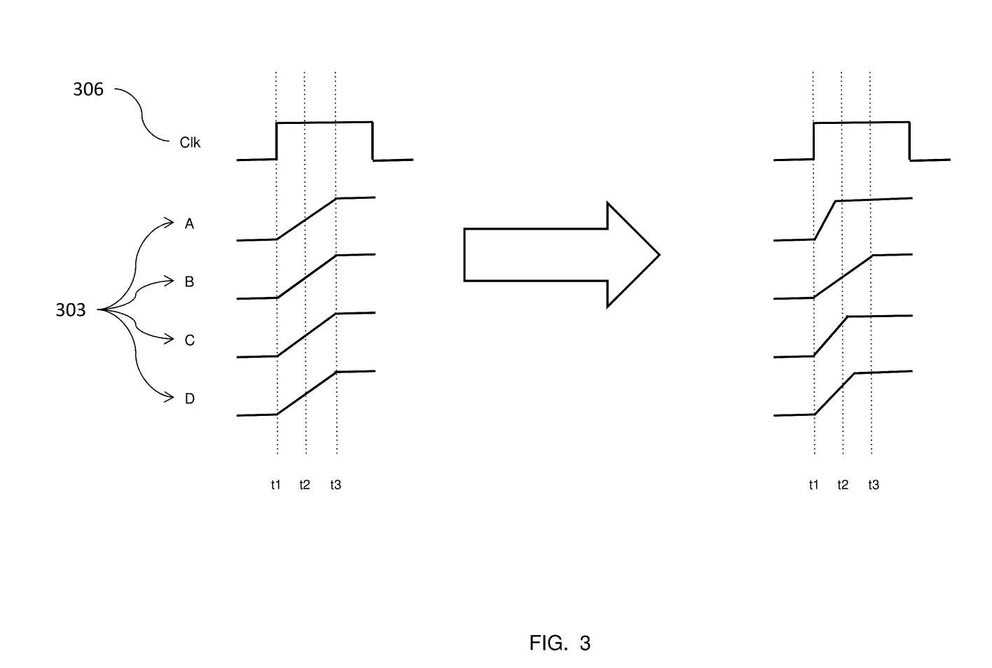

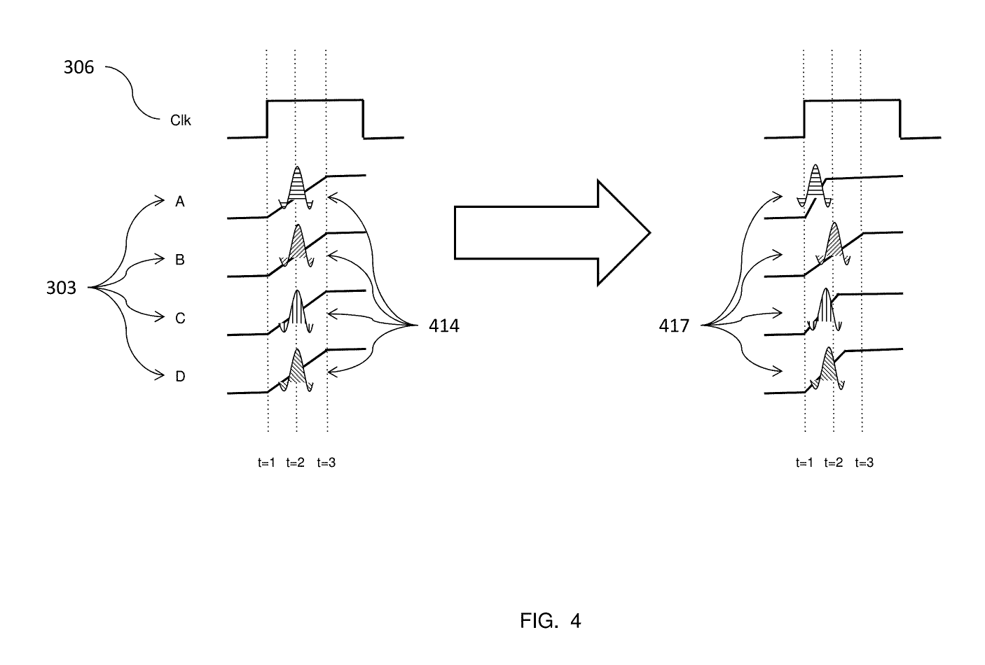

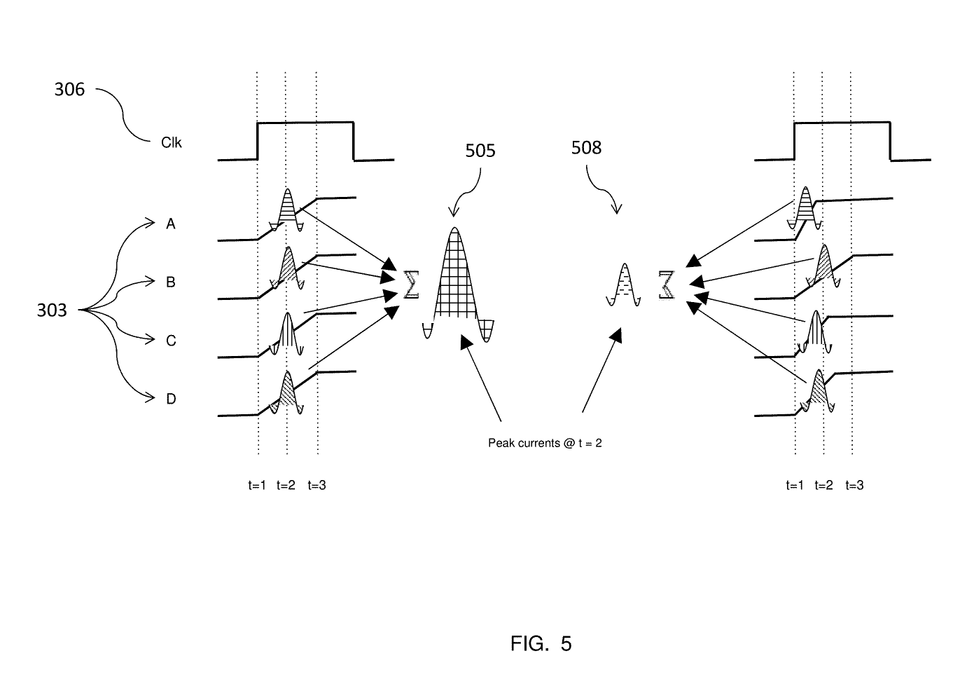

Typically, as shown in the left side of FIG. 3, library elements 303 (labeled A, B, C, and D) change state substantially simultaneously according to a clock signal 306. According to systems and methods herein, the timing of at least some of the library elements 303 can be adjusted, as shown on the right side of FIG. 3, in order to reduce peak power consumption and eliminate hot spots in the area. The left side of FIG. 4 shows the point of peak current 414 for each of the library elements 303. The peak current occurs for each library element 303 at time t=2. On the right side of FIG. 4, the point of peak current 417 of each library element 303 may be slewed to shift the point where each peak current occurs. The left side of FIG. 5 shows the point of peak current 414, which all occur at time t=2. The sum is indicated at 505. By applying a slew shift to the timing signal for at least some of the library elements 303, the point of peak current 417 is shifted such that, at time t=2 the sum of the peak currents, indicated at 508, is reduced. Furthermore, the current density is reduced at any given time.

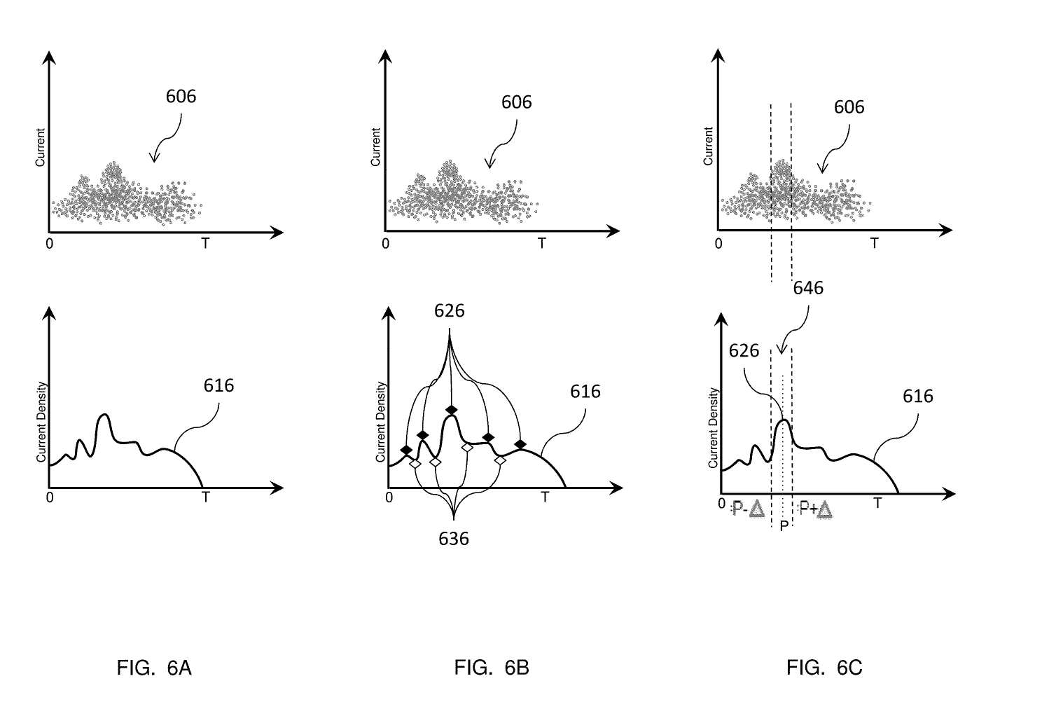

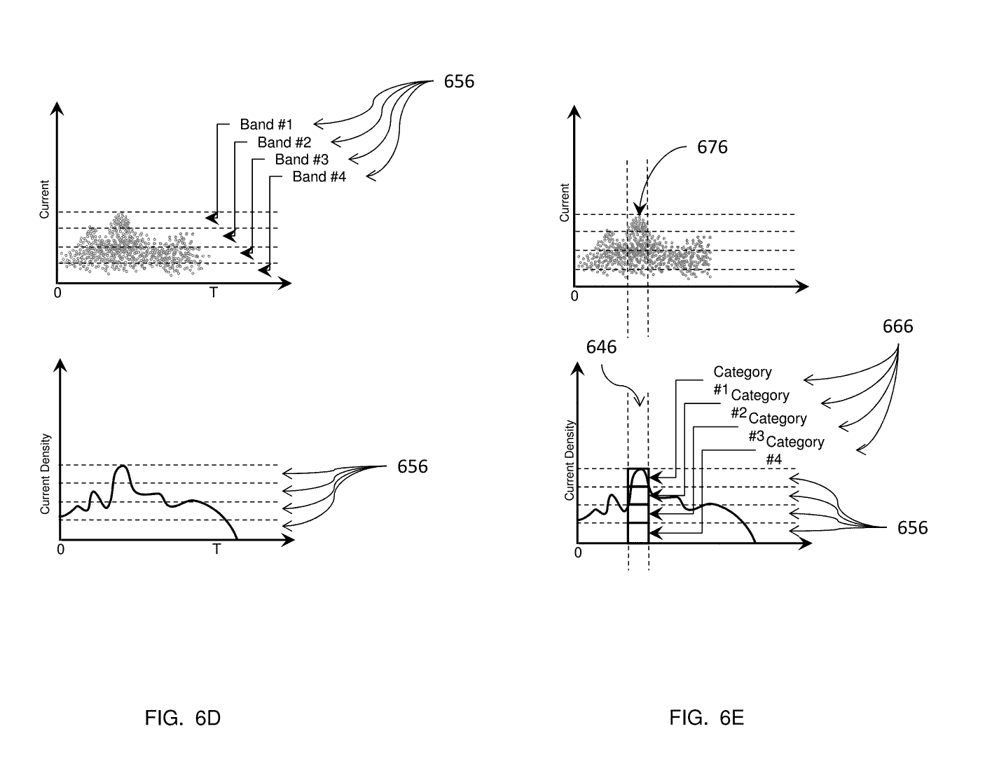

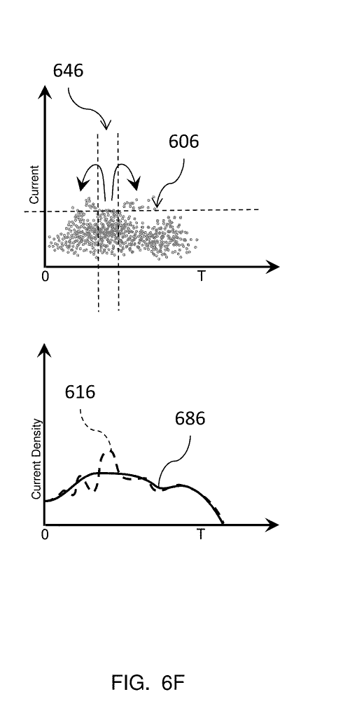

FIGS. 6A-6F illustrate various processing steps for identifying and selecting specific switching elements in order to reduce current density in the region of the IC chip, according to systems and methods herein. Specifically, FIG. 6A includes two graphs illustrating: a plot of peak current over time for each library element in a selected region; and a curve of current density over time given the plot of peak current over time. FIGS. 6B-6F each include these same graphs and illustrate processing steps performed relative thereto.

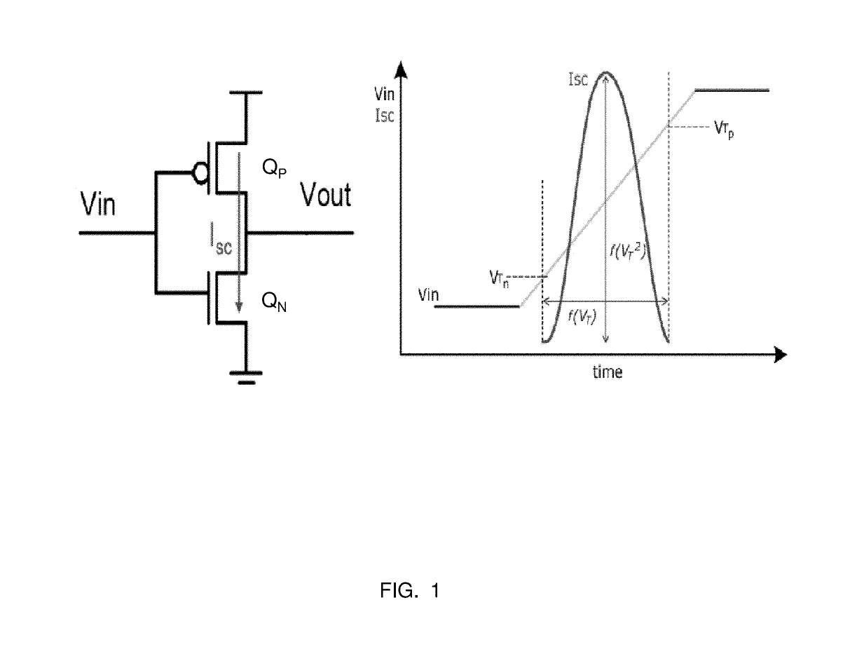

More specifically, as shown in FIG. 6A, a plot of the peak current consumed by each library element in the selected region, indicated generally as 606, is created. In addition, a plot of current density is created, as indicated at 616. Peak current occurs when V₁=V_{DD}/2. For that situation, both transistor Q_{N} and Qₚ (FIG. 1) are in saturation. As is known by one of ordinary skill in the art, the current through a MOSFET when in saturation is K times the excess gate voltage squared. For this case, V_{GSN}=V₁=V_{DD}/2, thus:

$$\begin{matrix}{i}_{peak} = {{K}_{n} ( {V}_{GSN} - {V}_{tn} )}^{2} \\ = {{K}_{n} ( {V}_{DD} / 2 - {V}_{tn} )}^{2}\end{matrix}$$

As shown in FIG. 6B, the peaks 626 and valleys 636 of the plotted current density are determined. As an example, peaks and valleys in the data can be defined as follows:

Given a sequence: D=9 5 3 7 7 16 11 12 9 15 18 21 19 18 . . .

A peak is defined as (D[n]>D[n−1] and D[n]>D[n+1])

A valley is defined as (D[n]<D[n−1] and D[n]<D[n+1])

In the exemplary sequence, the peaks are 16 and 21 at indices 5 and 11 (index base 0) and the valleys are 3 and 9 at indices 2 and 8 (index base 0).

As shown in FIG. 6C, regions, such as indicated at 646, are created around selected peaks 626. For example, if at time t=P is the peak, then region 646 can be defined as the area contained by coordinates t=P+Δ and t=P−Δ.

In FIG. 6D, current bands, such as indicated at 656, are defined in relation to the selected peak current. Each current band 656 may be defined as a percentage of the maximum current at the selected peak current. For example, as shown in FIG. 6D, the current bands 656 are divided into quarters. That is, if the maximum of the peak current is at 100, then the first band is from 100 to (100−25)=75; the second band is from 75 to (75−25)=50; the third band is from 50 to (50−25)=25; and the fourth band is from 25 to (25−25)=0. Other numbers of current bands 656 can be used.

In FIG. 6E, the current bands 656 are superimposed on the region 646 to define categories 666. Arrow 676 points to the target library elements in Category #1.

As shown in FIG. 6F, target library elements in Category #1 are evaluated based on slack margin to determine if their peak current can be moved towards the valleys 636 in order to reduce the current density in the region 646. As illustrated with reference to FIGS. 3-5, the timing of signal paths in the region 646 can be adjusted to delay or speed up switching of the library elements within the region 646 in order to misaligned the points of peak current resulting in comparably flat current density graph, indicated as 686.

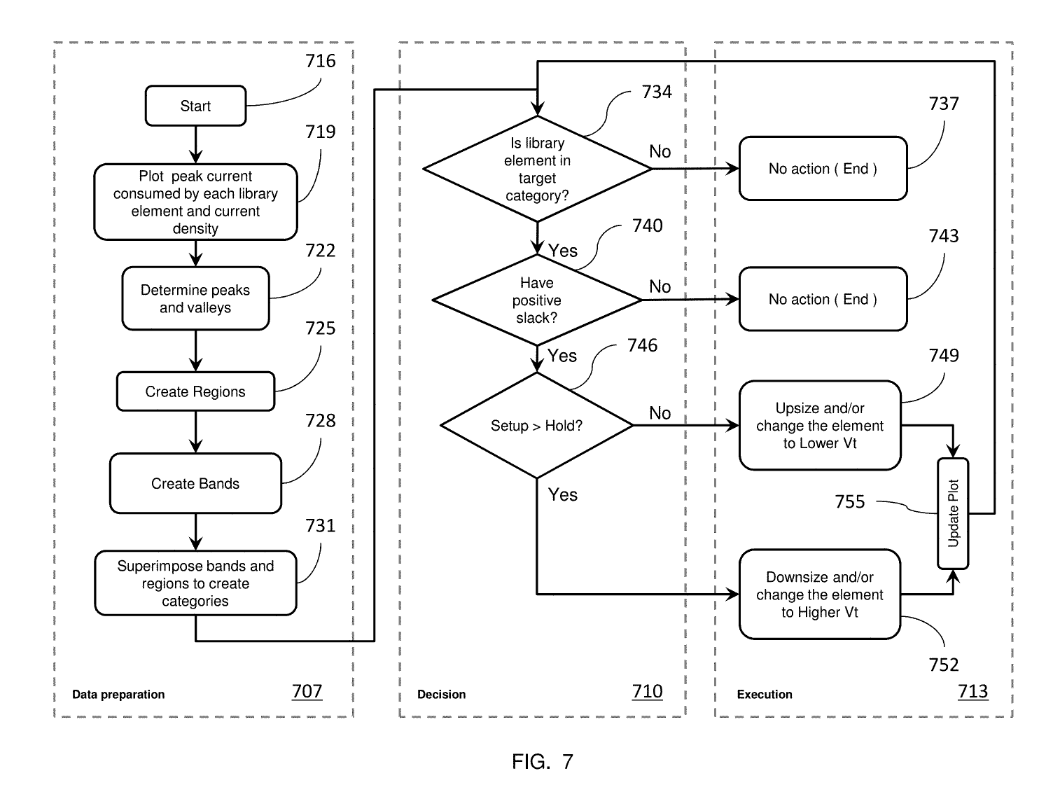

Referring to FIG. 7, which shows a flow chart illustrating aspects of systems and methods herein, the above-described process is divided into three phases: the data preparation phase 707, the decision phase 710, and the execution phase 713.

The data preparation phase 707 begins at block 716 and proceeds immediately to block 719. At block 719, the peak current consumed by each library element and the current density is plotted, as shown in FIG. 6A. At block 722, the peaks and valleys of the plotted current density are determined, as shown in FIG. 6B. At block 725, regions are created around selected peaks, as shown in FIG. 6C. At block 728, current bands are defined in relation to the selected current peak, as shown in FIG. 6D. At block 731, the current bands are superimposed on the regions to define categories, as shown in FIG. 6E.

The first step of the decision phase 710 is at block 734. At block 734, it is determined if there is a library element in the target category, as indicated by arrow 676 in FIG. 6E. If there are no library elements in the target category, no action is taken, and the process ends, as shown at block 737. If there are library elements in the target category, the process continues to block 740. At block 740, it is determined if the library element in the target category has available slack to adjust timing of the target library element. If the target library element does not have positive slack, no action is taken, and the process ends, as shown at block 743. If the target library element has positive slack, the process continues to block 746, the output of which leads to the execution phase 713.

At block 746, it is determined if the setup timing margin for the library element in the target category with available slack is greater than the hold timing margin. If the setup timing margin is less than the hold timing margin, a larger target library element can be used or a target library element with a lower threshold voltage can be used, as shown at block 749. Otherwise, if the setup timing margin is greater than the hold timing margin, a smaller target library element can be used or a target library element with a higher threshold voltage can be used, as shown at block 752. In either case, the plots of peak current consumed by each library element and current density, as shown at block 755 are updated, which ends the execution phase 713. The process then reverts to block 734 to determine if there is another library element in the target category.

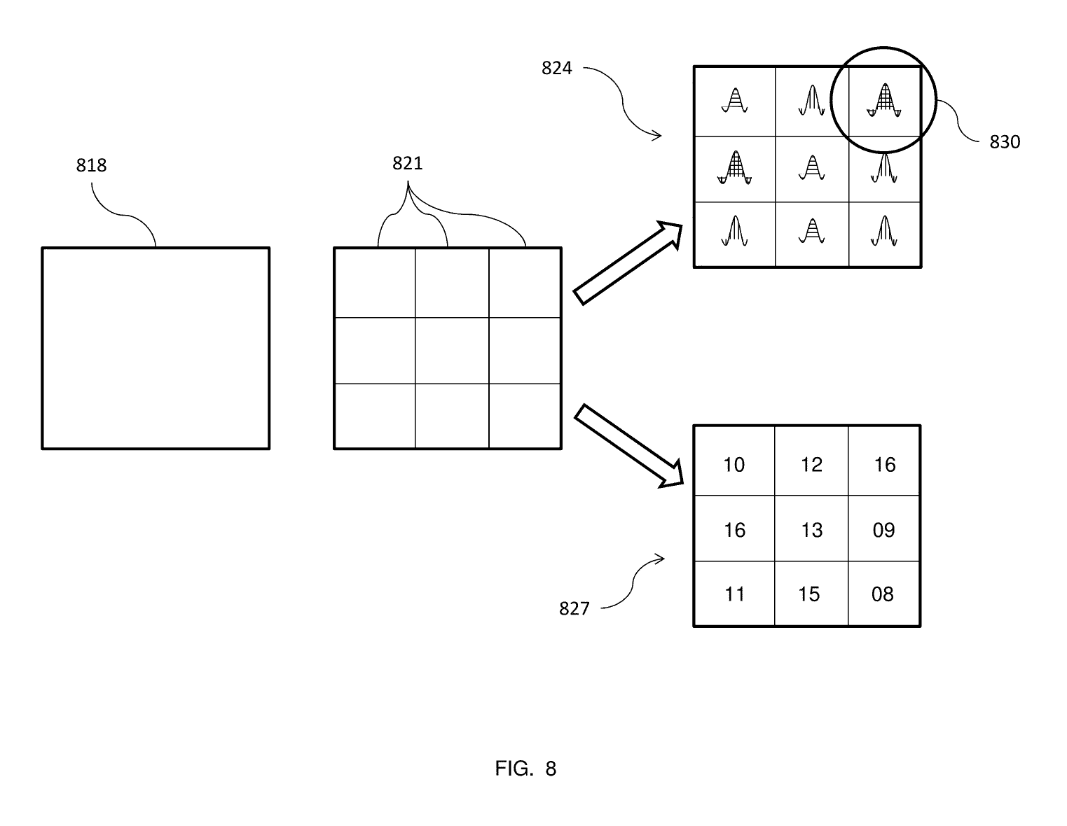

FIG. 8 shows an integrated circuit (IC) chip, indicated generally as 818. According to systems and methods herein, the IC chip 818 may be divided into several physical grid areas 821 for path based Vt/area recovery. Such path based Vt/area recovery may be based on:
Availability of positive slack
Attempts to reduce the cell sizes in the path
Attempts to change Vt types from higher to lower Vt.

For each pre-defined physical grid area, the dynamic power consumption is determined, illustrated at 824. Dynamic power consumption can be determined in a similar manner as described with reference to FIGS. 6A-6C. Similarly, for each pre-defined physical grid area, the static power consumption is determined, illustrated at 827. Static power consumption can be determined based on device content, temperature, and voltage. Note, for exemplary purposes, the physical grid area at 830 shows relatively higher power consumption.

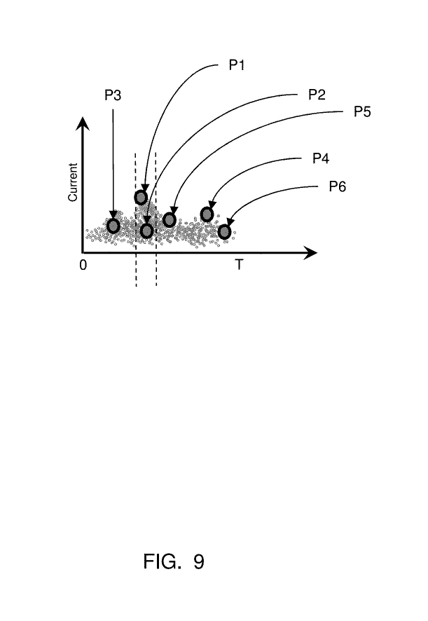

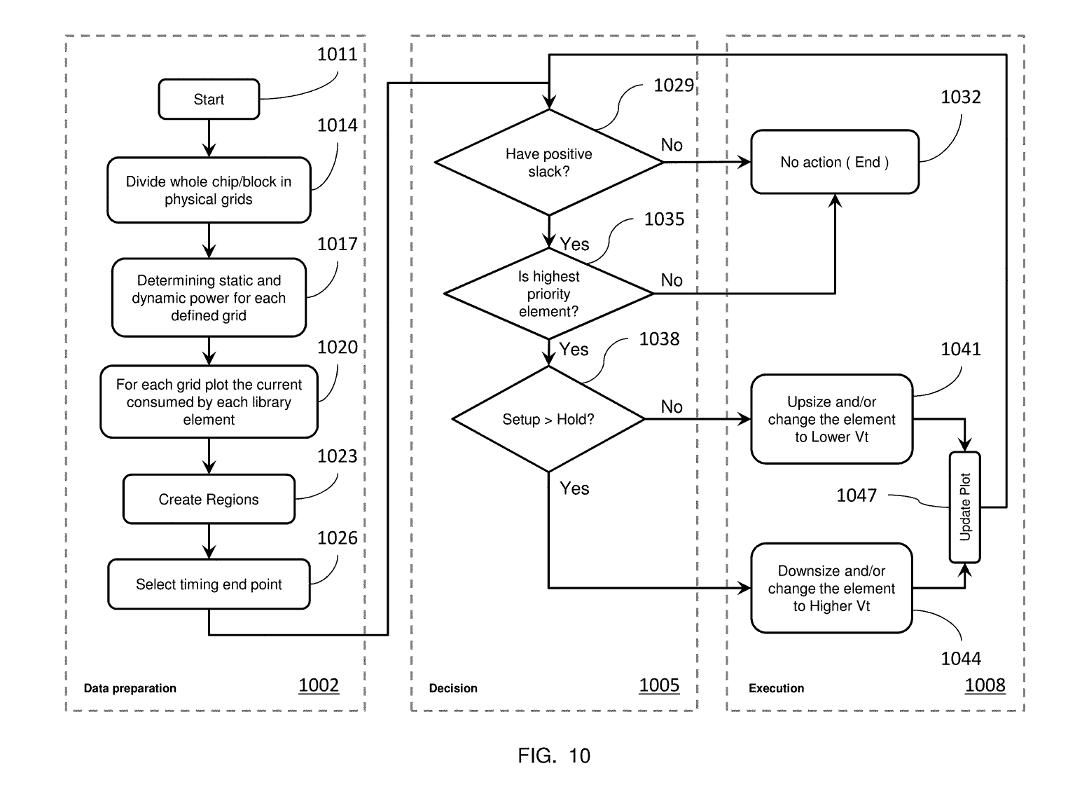

Library elements can be prioritized based on their physical location on the IC chip 818, as well as time domain location in the plot of peak current and current density for the physical grid area 830, which is selected for having relatively higher power consumption. FIG. 9 illustrates selection of target library elements according to priority in the selected physical grid area 830. That is, library elements in the relatively higher power consumption areas may be given higher priority. As shown in FIG. 9, the circles represent the library elements in the path with positive slack and their time domain location. In FIG. 9, the element P1 has the highest priority because it is at the highest peak and will have a greater effect on Vt/area recovery. The element P2 contributes to the peak at P1 and, therefore, has next priority. Element P3 is earliest in the time domain, and has the next priority. Elements P4 and P5 have the next highest peaks. In this example, for Vt/area recovery, the order in which the library elements should be modified is P1>P2>P3>P4>P5>P6.

In general, the process for path based Vt/area recovery includes selecting a path for recovery, determining if there is positive slack in the path, and, if there is available slack, changing selected elements in the path to modify the timing and/or moving to a lower performance device. FIG. 10 shows a flow chart illustrating aspects of systems and methods herein, using priority of the library elements in a selected physical grid area that may be modified. As described above, the process is divided into three phases: the data preparation phase 1002, the decision phase 1005, and the execution phase 1008.

The data preparation phase 1002 begins at block 1011 and proceeds immediately to block 1014. At block 1014, the chip is divided into physical grid sections, as shown in FIG. 8. At block 1017, the static and dynamic power for each physical grid section is determined. At block 1020, the peak current consumed by each library element and the current density is plotted, as shown in FIG. 6A, and the peaks and valleys of the plotted current density are determined, as shown in FIG. 6B. At block 1023, regions are created around selected peaks, as shown in FIG. 6C. At block 1026, a timing endpoint is selected. That is, every sequential element in the selected physical grid area is considered as a potential end point for timing perspective. The elements are timed according to a timing budget using a timing tool, as would be known by one of ordinary skill in the art.

The first step of the decision phase 1005 is at block 1029. At block 1029, it is determined if there is positive slack in the timing path. If there is no slack in the timing path, no action is taken, and the process ends, as shown at block 1032. If there is slack in the timing path, the process continues to block 1035. At block 1035, the priority of the cell is determined. That is, it is determined if the cell in the region of interest is the P1 priority library element as shown in FIG. 9. If it is not the P1 library element, no action is taken, and the process ends, as shown at block 1032. If the cell in the region of interest is the highest priority cell, the process continues to block 1038, the output of which leads to the execution phase 1008.

At block 1038, it is determined if the setup timing margin for the P1 cell in the region of interest is greater than the hold timing margin. If the setup timing margin is less than the hold timing margin, a larger target library element can be used or a target library element with a lower threshold voltage can be used, as shown at block 1041. Otherwise, if the setup timing margin is greater than the hold timing margin, a smaller target library element can be used or a target library element with a higher threshold voltage can be used, as shown at block 1044. In either case, the plots of peak current consumed by each library element in the physical grid section and current density are updated, as shown at block 1047, which ends the execution phase 1008. The process then reverts to block 1029 to determine if there is another path in the region of interest having positive slack, based on order of priority.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

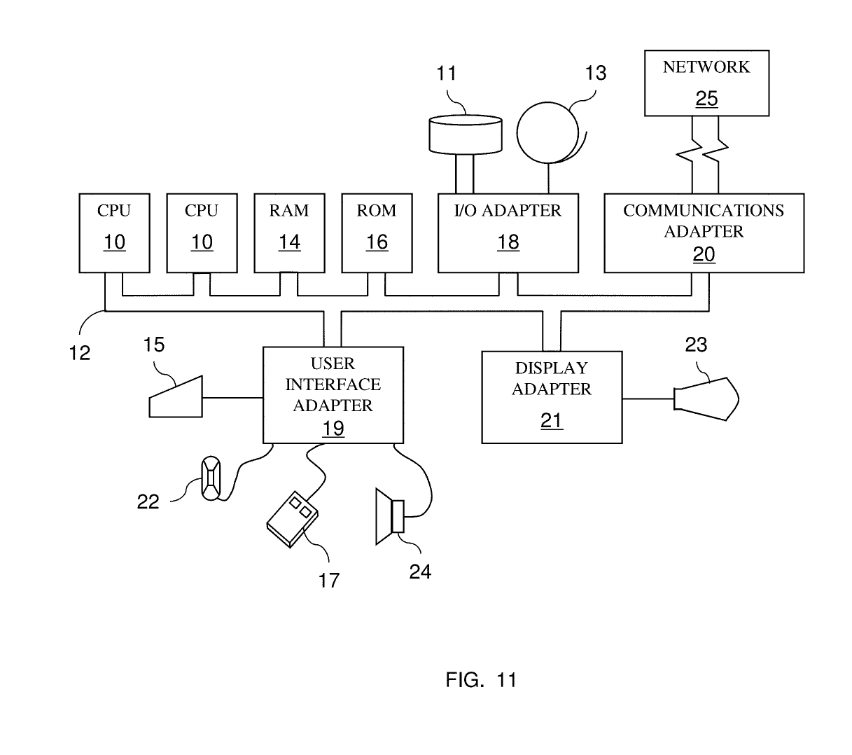

A representative hardware environment for implementing the systems and methods herein is depicted in FIG. 11. This schematic drawing illustrates a hardware configuration of an information handling/computer system in accordance with the systems and methods herein. The system includes at least one processor or central processing unit (CPU) 10. The CPUs 10 are interconnected via system bus 12 to various devices such as a Random Access Memory (RAM) 14, Read Only Memory (ROM) 16, and an Input/Output (I/O) adapter 18. The I/O adapter 18 can connect to peripheral devices, such as disk units 11 and tape drives 13, or other program storage devices that are readable by the system. The system can read the instructions on the program storage devices and follow these instructions to execute the methodology of the systems and methods herein.

In FIG. 11, CPUs 10 perform various processing based on a program stored in a Read Only Memory (ROM) 16 or a program loaded from a peripheral device, such as disk units 11 and tape drives 13 to a Random Access Memory (RAM) 14. In the RAM 14, required data when the CPU 10 performs the various processing or the like is also stored as necessary. The CPU 10, the ROM 16, and the RAM 14 are connected to one another via a bus 12. An input/output adapter 18 is also connected to the bus 12 to provide an input/output interface, as necessary. A removable medium, such as a magnetic disk, an optical disk, a magneto-optical disk, a semiconductor memory, or the like, is installed on the peripheral device, as necessary, so that a computer program read therefrom may be installed into the RAM 14, as necessary.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 including a network interface card such as a LAN card, a modem, or the like connects the bus 12 to a data processing network 25. The communication adapter 20 performs communication processing via a network such as the Internet. A display adapter 21 connects the bus 12 to a display device 23, which may be embodied as an output device such as a monitor (such as a Cathode Ray Tube (CRT), a Liquid Crystal Display (LCD), or the like), printer, or transmitter, for example.

The flowchart and block diagrams in the figures illustrate the architecture, functionality, and operation of possible implementations of systems, methods, and computer program products according to various examples disclosed herein. In this regard, each block in the flowchart or block diagrams may represent a module, segment, or portion of code, which includes one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be understood that the terminology used herein is for the purpose of describing particular examples of the disclosed structures and methods and is not intended to be limiting of this disclosure. For example, as used herein, the singular forms “a”, “an”, and “the” are intended to include the plural forms as well, unless the context clearly indicates otherwise. Additionally, as used herein, the terms “comprises”, “comprising”, “includes”, and/or “including”, when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

The corresponding structures, materials, acts, and equivalents of all means or step plus function elements in the claims below are intended to include any structure, material, or act for performing the function in combination with other claimed elements as specifically claimed. The descriptions of the various systems and methods of the present disclosure have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

It is contemplated that other applications may be developed using the structure and techniques described herein. While various examples are described herein, it will be appreciated from the specification that various combinations of elements, variations, or improvements therein may be made by those skilled in the art, and are within the scope of the disclosure. In addition, many modifications may be made to adapt a particular situation or material to the teachings of the disclosed concepts without departing from the essential scope thereof. Therefore, it is intended that the concepts not be limited to the particular examples disclosed as the best mode contemplated for carrying out the systems and methods herein, but that the systems and methods will include all features falling within the scope of the appended claims.

What is claimed is:

1. A method comprising:
determining a switching window for library elements of an integrated circuit design in a region of an integrated circuit (IC) chip;
determining points of peak current for the library elements within the switching window; and
adjusting timing of signal paths in the region of the IC chip to delay or speed up switching of the library elements within the region in order to misalign the points of peak current and maintain current density in the region below a predetermined threshold.

2. The method according to claim 1, further comprising:
plotting peak current consumed by each library element in the integrated circuit design;
calculating current density for the library elements in the integrated circuit design; and
creating a plot of current density for the library elements.

3. The method according to claim 2, further comprising:
determining peaks and valleys in the plot of current density for the library elements;
defining regions in the plot of current density between adjacent valleys;
defining current bands in each region as a percentage of the maximum current in the region;
creating categories, based on the current bands in the region; and
identifying target library elements of the library elements in the region, the target library elements being in a target category having additional usable timing margin.

4. The method according to claim 3, the adjusting the timing of signal paths further comprising:
changing size of a target library element in the integrated circuit design or adjusting threshold voltage of the target library element in the integrated circuit design to reduce the current density in the target category.

5. The method according to claim 1, further comprising:
defining physical grid areas for the IC chip; and
for each physical grid area, plotting the peak current consumed by each library element of the integrated circuit design and the current density.

6. The method according to claim 5, further comprising:
identifying target library elements in the physical grid area having additional usable timing margin.

7. The method according to claim 6, further comprising:
prioritizing target library elements based on physical location of the target library elements in the physical grid area according to the peak current and the additional usable timing margin; and
based on order of priority of the target library elements, changing size of the target library element in the integrated circuit design or adjusting threshold voltage of the target library element in the integrated circuit design.

8. A method, comprising:
defining physical grid areas for an integrated circuit (IC) chip;
for each physical grid area, determining a switching window for library elements of an integrated circuit design;
determining points of peak current for the library elements within the switching window;
selecting a physical grid area of the IC chip having peak current density;
identifying target library elements in the physical grid area having additional usable timing margin;
prioritizing target library elements based on physical location in the physical grid area according to the peak current and the additional usable timing margin; and
based on order of priority of the target library elements, changing one of the target library elements in the physical grid area of the IC chip to recover area within the physical grid area of the IC chip.

9. The method according to claim 8, further comprising, for each physical grid area:
plotting peak current consumed by each library element in the IC design;
calculating current density for the library elements in the IC design; and
creating a plot of current density for the library elements.

10. The method according to claim 9, further comprising:
determining peaks and valleys in the plot of current density for the library elements;
defining regions in the plot of current density between adjacent valleys;
defining current bands in each region as a percentage of the maximum current in the region;
creating categories, based on the current bands in the region; and
identifying target library elements of the library elements in the region, the target library elements being in a target category having additional usable timing margin.

11. The method according to claim 10, further comprising:
changing size of a target library element in the integrated circuit design to reduce the current density in a selected physical grid area of the IC chip.

12. The method according to claim 10, further comprising:
changing threshold voltage of a target library element in the integrated circuit design to reduce the current density in a selected physical grid area of the IC chip.

13. The method according to claim 8, the target library elements comprising switching devices.

14. A computer program product for reducing hot spots to improve chip performance in an integrated circuit design, the computer program product comprising a computer readable storage medium having program instructions embodied therewith, the program instructions being readable and executable by a computerized device to cause the computerized device to perform a method comprising:
determining a switching window for library elements of an integrated circuit design in a region of an integrated circuit chip;
determining points of peak current for the library elements within the switching window; and
adjusting timing of signal paths in the region to delay or speed up switching of the library elements within the region in order to misalign the points of peak current and maintain current density in the region below a predetermined threshold.

15. The computer program product according to claim 14, the method further comprising:
plotting peak current consumed by each library element in the integrated circuit design;
calculating current density for the library elements in the integrated circuit design; and
creating a plot of current density for the library elements.

16. The computer program product according to claim 15, the method further comprising:
determining peaks and valleys in the plot of current density for the library elements;
defining regions in the plot of current density between adjacent valleys;
defining current bands in each region as a percentage of the maximum current in the region;
creating categories, based on the current bands in the region; and
identifying target library elements of the library elements in the region, the target library elements being in a target category having additional usable timing margin.

17. The computer program product according to claim 16, the adjusting the timing of signal paths further comprising:
changing size of a target library element in the integrated circuit design or adjusting threshold voltage of the target library element in the integrated circuit design to reduce the current density in the target category.

18. The computer program product according to claim 14, the method further comprising:
defining physical grid areas for the IC chip; and
for each physical grid area, plotting the peak current consumed by each library element of the integrated circuit design and the current density.

19. The computer program product according to claim 18, the method further comprising:
identifying target library elements in the physical grid area having additional usable timing margin.

20. The computer program product according to claim 19, the method further comprising:
prioritizing target library elements based on physical location of the target library elements in the physical grid area according to the peak current and the additional usable timing margin; and
based on order of priority of the target library elements, changing size of the target library element in the integrated circuit design or adjusting threshold voltage of the target library element in the integrated circuit design to recover area in the physical grid area.
